(19) United States
(12) Patent Application Publication
(10) Pub. No.: US 2021/0274063 A1
(43) Pub. Date: Sep. 2, 2021

(54) COLOR FORTIFICATION IN IMAGES

(71) Applicant: Hewlett-Packard Development Company, L.P., Spring, TX (US)

(72) Inventors: Jesse O. Sutherland, III, Vancouver, WA (US); Wesley R. Schalk, Vancouver, WA (US); Benjamin Hoopes, Boise, ID (US); Morgan T. Schramm, Vancouver, WA (US); David M. Berfanger, Vancouver, WA (US)

(73) Assignee: Hewlett-Packard Development Company, L.P., Spring, TX (US)

(21) Appl. No.: 17/256,440

(22) PCT Filed: Sep. 13, 2018
(86) PCT No.: PCT/US2018/050945

§ 371 Date: Dec. 28, 2020

(51) Int. Cl. H04N 1/62; H04N 1/54; H04N 1/58

(52) U.S. Cl. CPC H04N 1/62; H04N 1/58; H04N 1/54

(57) ABSTRACT

An example computer-readable medium storing machine-readable instructions that, when executed by a processor, cause the processor to receive an image, identify a first color region in the image, the first color region having a color level below a color level threshold, and fortify the first color region.

### BACKGROUND

Documents may be duplicated using a copier, scanning and printing the document, or taking a picture with a camera and printing the document. Image processing may be performed on the document image before the document is printed.

### BRIEF DESCRIPTION OF THE DRAWINGS

Various examples will be described below referring to the following figures:

FIG. 1 shows a copier that fortifies a color region of a document image in accordance with various examples;

FIG. 2 shows a copier that fortifies non-white color regions of a document image in accordance with various examples;

FIG. 3 shows a copier that fortifies a first and second color region in accordance with various examples;

FIG. 4 shows a computer-readable medium with machine-readable instructions to fortify a color region in accordance with various examples;

FIG. 5 shows a computer-readable medium with machine-readable instructions to fortify a first and second color region in accordance with various examples;

FIG. 6 shows a method of scanning an image and fortifying a color region of the image in accordance with various examples; and

FIG. 7 shows a method of scanning an image and fortifying a first and second color region of the image in accordance with various examples.

### DETAILED DESCRIPTION

Copying or scanning and printing documents may result in a depletion of coloration. Reds, blues, blacks, and other colors may fade to non-visible color levels with serial duplication of a document.

When copying a document, or otherwise scanning or imaging a document before printing, the document image may be analyzed and fortified before being printed. Color regions with low color levels may have their coloration increased to prevent the color region from being difficult or impossible to see after printing.

In one example in accordance with the present disclosure, an apparatus is provided. The apparatus comprises a computer-readable medium storing machine-readable instructions that, when executed by a processor, cause the processor to receive an image, identify a first color region in the image, the first color region having a color level below a color level threshold, and fortify the first color region.

In one example in accordance with the present disclosure, a method is provided. The method comprises scanning a surface to produce an image, analyzing the image to identify a first color region in the image, determining that a color level of the first color region is below a color level threshold, and fortifying the first color region in response to the determination.

In one example in accordance with the present disclosure, an apparatus is provided. The apparatus comprises an optical sensor to scan an image, a computer-readable medium, coupled to a processor, to store machine-readable instructions which, when executed by the processor, cause the processor to receive the image via the optical sensor, identify a first color region in the image, the first color region having a color level below a color level threshold, and fortify the first color region, and a printer coupled to the processor to print the image after the fortification by the processor.

Color is meant to include black, white, and other colors, such as red, blue, and green. Black may include shades of black, such as greys.

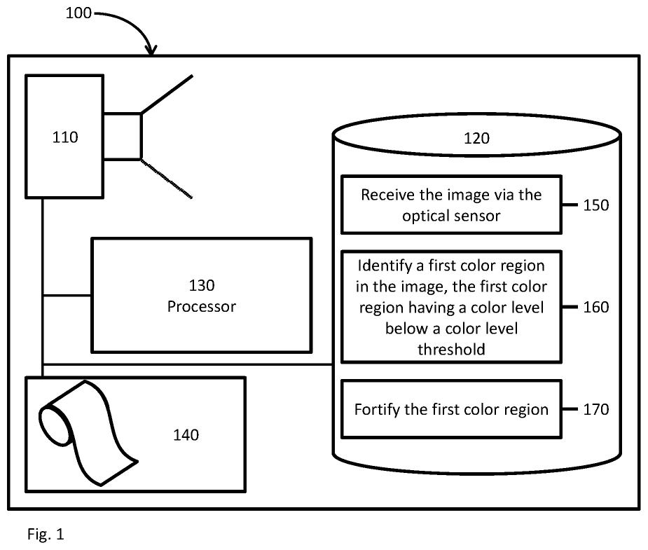

FIG. 1 shows a copier 100 that fortifies a color region of a document image in accordance with various examples. The copier may include an optical sensor 110, a computer-readable medium 120, a processor 130, and a printer 140. The optical sensor 110, computer-readable medium 120, processor 130, and printer 140 may be coupled together via a bus. The copier 100 may be a photocopier, a digital copier, or an all-in-one printer that may independently perform scanning, copying, printing, or faxing. The copier 100 may be connected to a network, which may be coupled to the bus.

Optical sensor 110 may comprise photoelectric sensors to scan an image from a surface. The optical sensor 110 may comprise a charged couple device (CCD) or a contact image sensor (CIS). The optical sensor 110 may be able to obtain color image scans. In various examples, the optical sensor 110 may perform a line scan of the surface, such as scanning the width of the document from one side to another. For example, the scan may be performed as a flatbed scanner where the optical sensor 110 moves across the surface to be scanned. The scan may be performed in a sheet-fed configuration where the scanned item is fed through an area including the optical sensor 110. In various examples, the optical sensor 110 may perform the scan like a camera or comprise a camera, taking a picture of the document. Optical sensor 110 may obtain an image for processing by the processor 130 and then printing by the printer 140. The image may be stored in the computer-readable medium 120 while being processed by the processor 130.

Computer-readable medium 120 may comprise volatile or non-volatile memory, such as a hard drive, solid state drive (SSD), flash memory, random access memory (RAM), or electrically erasable programmable read-only memory (EEPROM). Computer-readable medium may comprise machine-readable instructions 150, 160, 170 or data. The machine-readable instructions 150, 160, 170 may be executed by processor 130. Machine-readable instruction 150, when executed, may cause processor 130 to receive the image via the optical sensor 110. Machine-readable instruction 160, when executed, may cause processor 130 to identify a first color region in the image, the first color region having a color level below a color level threshold. Machine-readable instruction 170, when executed, may cause processor 130 to fortify the first color region.

The processor 130 may comprise a microprocessor, a microcomputer, a controller, a field programmable gate array (FPGA), or discrete logic to execute machine-readable instructions.

The printer 140 may deposit color on a printable surface, such as by using inkjet or laser printing techniques. The surface may be paper, cardboard, plastic, metal, or another suitable printing surface. The color used by the printer 140 may include black or non-black colors. For example, color printers may use black, magenta, cyan, and yellow colorant and print them in various combinations to provide printing of color documents and images. Color printers may use black, red, green, and blue colorant to print color documents. Colorant includes ink, toner, marking material, pigmentation, or other substance used to color the object being printed on.

The image received via the optical sensor 110 may comprise a color image taken of a color document. The image may comprise color regions. For example, an image of the Texas state flag may include a color region that is rectangular with a color of red, a color region that is rectangular with a color of white, a color region that is rectangular with a color of blue and having a cutout region in the shape of a star, and a color region that is white in the shape of a star and surrounded by the blue color region. The image may include black color regions, such as outlining the shape of the flag or acting as a border between the other color regions.

A color region is a contiguous region where the coloring of the region is consistent across the region, such as being the same color of blue. In various examples, the color region may encompass a range of related colors, such as very close shades of blue, or some other common characteristic. The different shades may be attributable to the resolution or margin of error of the optical sensor 110, or attributes of a prior copier or printer used in copying or printing the image to a document. Settable parameters may be used in determining when colors are close enough to be part of the same color region or should be part of separate color regions. The processor may maintain separate shades within a color region or modify the coloration with a color region to be the same shade of color. In various examples, the color region may include a halftoned region, such as a region with a white background and red points distributed across the region to provide a pinkish hue. The points may be in close proximity as to be invisible to the human eye, or they may be visible. In such a case, the color region may be identified as a region with a small variation in the percentage of red point coverage or with a small variation in the distribution of red points. A color region may include multiple colors, such as a distribution of magenta and cyan points that may be viewed as purple to the human eye.

A color region may have a color level below a color level threshold. The color level threshold may be a value below which it is known that the human eye cannot see the color, or has difficulty seeing it. The color level threshold may be a value below which it is known that depletion of the color region, discussed later herein, may reduce the color so that the human eye cannot see the color, or has difficulty seeing it. The color level threshold may be set higher than the minimum discernable color level, as different individuals may have different abilities to see that color level. The color level threshold may vary for different colors. For example, yellow may be more difficult to see than magenta, so a higher color level threshold may be used for the color yellow than the color magenta. In analyzing a color such as orange, which may be printed using a combination of magenta and yellow colorant, the individual yellow or magenta coloration may be analyzed or processed separately. Black may have a higher color level threshold than magenta, cyan, or yellow, as black may indicate the presence of text. The color level threshold may vary depending on the size of the region. For example, the coloration of a larger region may be more discernable to the human eye than coloration of a small region, thus the larger region may use a lower color level threshold.

In identifying color regions, the analysis may examine the whole image, such as analyzing every pixel or a sub-set such as every tenth pixel. The analysis may include performing a whole-image analysis to determine a black/white contrast or how dark, light, or red the image is. Such whole-image statistics may affect the identification of color regions. For example, an image that has a predominance of red may use a smaller range of red color than blue color in determining when to divide related shades of red or blue into separate color regions.

Color regions where the color level is below the color level threshold may be fortified or tagged as a region that should not be depleted. Fortification is the addition of coloration. Coloration may be evenly or unevenly distributed in the color region. By fortifying a color region, the color of the color region or existence of the color region may be more easily seen by the human eye on a printout or copy of the image. White regions may not be fortified, as they are supposed to remain white. Thus another color level threshold may be used to differentiate between a color region that should be treated as white and a non-white color region.

In various examples, fortification may be performed using black colorant, even if the color of the color region is non-black. Black coloration may be added to the color region. While this may not preserve the color of the color region as well as fortifying using a color corresponding to the color of the color region, fortifying with black coloration may still allow the image to be seen after printing. For example, if the image is a Texas flag, the colors of the flag may be difficult or impossible to discern after black fortification and printing, though the different rectangular and star portions may still be apparent. Black coloration may be used because black colorant for the copier 100 may be cheaper than non-black colorant.

In various examples, fortification may be performed using a coloration corresponding to the color of the color region. For example, a color region may be the color orange. Fortification may be performed using a related orange color to make the color region darker, more vibrant, or otherwise more discernable after printing. When printing the image, the color orange may actually be produced by use of magenta and yellow colorant. Black may also be used in this fortification, either to help match the color of the color region or in order to make the color region more discernable after printing.

In various examples, fortification may be performed along the border of the color region, but not across the entire color region. For example, rather than adding coloration to the entire color region, coloration may be added along the border at a transition to other color regions, thus outlining the color region. The width of the region along the border that receives additional coloration may vary depending on the color of the region, the size of the region, or the shape of the region. The fortification may be a consistent fortification along the width or it may be a gradient. For example, the width directly adjacent to the border may receive more added coloration with the amount of coloration decreasing with the distance from the border. The gradient may be restricted to a certain distance from the border, with no added coloration after that distance, or the gradient may be across the whole color region.

In various examples, the processor 130 may also execute machine-readable instructions to perform character analysis. For example, by analyzing color regions, the processor 130 may detect that certain portions of the image contain characters or text. The color regions signifying text may be fortified differently than other color regions, such as color regions signifying text receiving more fortification. Color regions signifying text may have their outlines fortified, while other regions may have the entire region fortified. Lines or other graphic content may also be identified and fortified differently.

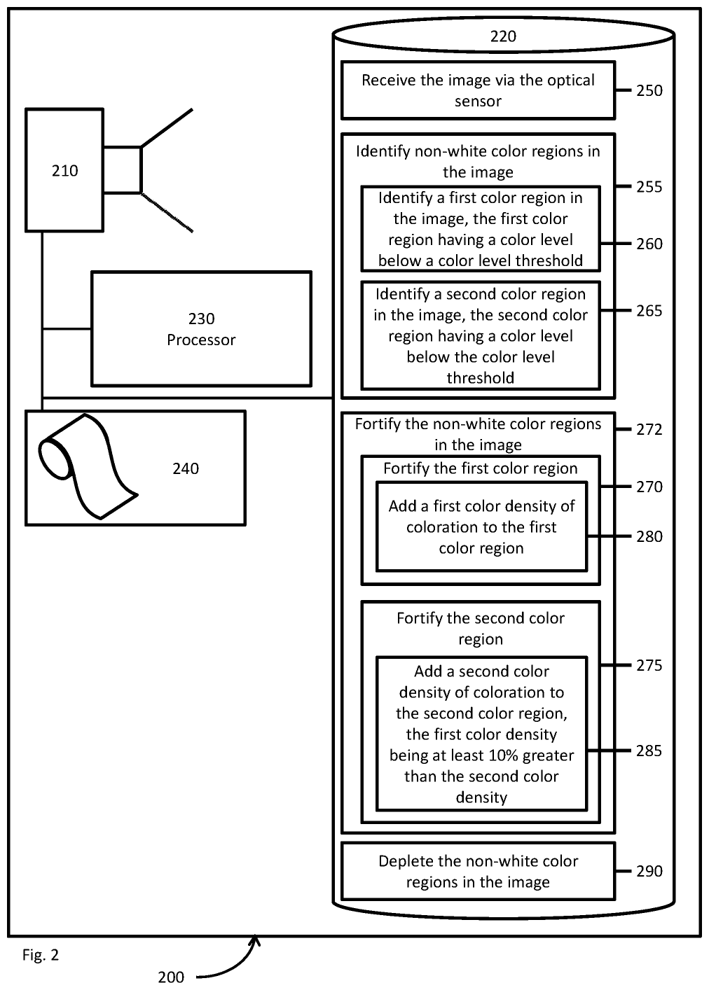

FIG. 2 shows a copier 200 that fortifies non-white color regions of a document image in accordance with various examples. The copier 200 may include an optical sensor 210, a computer-readable medium 220, a processor 230, and a printer 240.

The computer-readable medium 220 may include computer-readable instructions 250, 255, 260, 265, 272, 270, 280, 275, 285, 290. Processor 230 may execute the computer-readable instructions 250, 255, 260, 265, 272, 270, 280, 275, 285, 290. Machine-readable instruction 250 may cause the processor 230 to receive the image via the optical sensor. Machine-readable instruction 255 may cause the processor 230 to identify non-white color regions in the image. Machine-readable instruction 255 may comprise machine-readable instructions 260, 265. Machine-readable instruction 260 may cause the processor 230 to identify a first color region in the image, the first color region having a color level below a color level threshold. Machine-readable instruction 265 may cause the processor 230 to identify a second color region in the image, the second color region having a color level below the color level threshold. Machine-readable instruction 272 may cause the processor 230 to fortify the non-white color regions in the image. Machine-readable instruction 272 may comprise machine-readable instruction 270, which may comprise machine-readable instruction 280, and machine-readable instruction 275, which may comprise machine-readable instruction 285. Machine-readable instruction 270 may cause the processor 230 to fortify the first color region. Machine-readable instruction 280 may cause the processor 230 to add a first color density of coloration to the first color region. Machine-readable instruction 275 may cause the processor 230 to fortify the second color region. Machine-readable instruction 285 may cause the processor 230 to add a second color density of coloration to the second color region, the first color density being 10% (or more) greater than the second color density. Machine-readable instruction 290 may cause the processor 230 to deplete the non-white color regions in the image.

In various examples, color regions may be fortified by different amounts. For example, one color region may be larger and thus naturally more visible than another color region. The larger color region may be fortified less than the smaller color region. Different colors may be fortified by different amounts. For example, black may be fortified more than non-black colors. This may be because black may be more likely to indicate the presence of text. Information in black may be considered more valuable. Black colorant may also be cheaper than magenta, cyan, yellow, or other non-black colorant, thus fortifying black color regions more may still cost less than fortifying non-black color regions.

In various examples, color regions may be fortified by different amounts based on the color level of the color region. Multiple color level thresholds may be used, or a color level scale factor may be used. When using multiple color level thresholds, color regions between two thresholds may be fortified using a corresponding color density. When using a color scale factor, the color level may undergo a mathematical calculation, such as multiplication by a scale factor variable and addition of an offset, to determine a color density.

In various examples, color regions may be fortified by different amounts by using a different color density. The color density is the amount of coloration in an area. Using a halftoning technique, this may mean more dots per square inch. In various examples, color density may be the amount of coloration per square inch. For example, coloring a color region dark red versus pink, which may correspond to a volume of magenta colorant when printed. This may allow a document image that includes pink and red to be identifiable as different colors if the document image is depleted after fortification.

Depletion is reducing the coloration of the image. Depletion may be a wholesale reduction of some percentage of the coloration, such as reducing coloration by 90%. Depletion may reduce different colors by different amounts, such as reducing black color by 20% and non-black colors by 90%. Depletion may allow for a document to be printed or copied at lower cost, as less colorant is being used. Depletion may be a setting of the copier 200 or a printer. When the copier 200 is set to perform a depletion, the copier 200 may first identify color regions on the document image that would be depleted below visible color levels and fortify those color regions before depletion or determine those color regions should not be depleted.

As printers and copiers use depletion to save colorant and lower operating expenses, identification of depleted documents and fortification of the documents when scanning or copying the documents may be beneficial. Specifically, copying a depleted document while using a depletion mode may deplete information to the point of it being invisible or lost. If a document is printed in a depletion mode that depletes 90% of the non-black color, copying it with another 90% depletion of non-black color may leave 1% of the original non-black coloration in the copy. Such a low amount of coloration may not be visible to the human eye. By identifying a document as already having been depleted and declining to further deplete the document or fortifying portions of the document before depleting it, information may be saved that would otherwise be lost. Fortification and depletion may also be implemented on portions of the document, for example, if a picture from a depleted document is cut and glued onto a non-depleted document, the depleted picture may be identified and fortified, but not the remainder of the non-depleted document. In various examples, the non-depleted portion of the document may be depleted on a copy, while the depleted picture may be fortified or copied as-is.

In various examples, the entire document image may be fortified regardless of the color levels of individual color regions. Different copies may be produced depending on the particular fortification and depletion techniques used. A fortification and depletion may be matched so that the copy is indistinguishable from a copy made without any fortification and depletion. A fortification and depletion may result in a copy where the color regions are outlined with more coloration than the original, but the interiors of the color regions do not have visible coloration. A fortification and depletion may result in a copy where color regions with low color levels in the original are unaffected, but color regions with high color levels in the original are depleted. Other results may also occur.

In various examples, a method for depletion may analyze the color levels of color regions. If the color level of a color region is above a color level threshold, depletion may be performed on that color region. If the color level is below the color level threshold, the color region may not be depleted. In this way, a region-based depletion may be carried out. Multiple color level thresholds may be used, depleting color regions with higher color levels by a certain percentage and depleting color regions with lower color levels by a smaller percentage. A scale factor may also be used to provide a gradual depletion that is calculated based on a scale factor and the color level of a color region.

In various examples, fortification may be performed using a color map. A color map associates one color with a second color. When applied to the document image, instances of the first color are changed to the second color. For example, a light pink color may be mapped to a darker pink or a red color via a color map. The color map may map all addressable colors in a color encoding or map colors identified as present in the document image. The color map may be a predefined map used when modifying the document image or may be created based on analysis of the document image, such as the black/white contrast or spectrum of colors present.

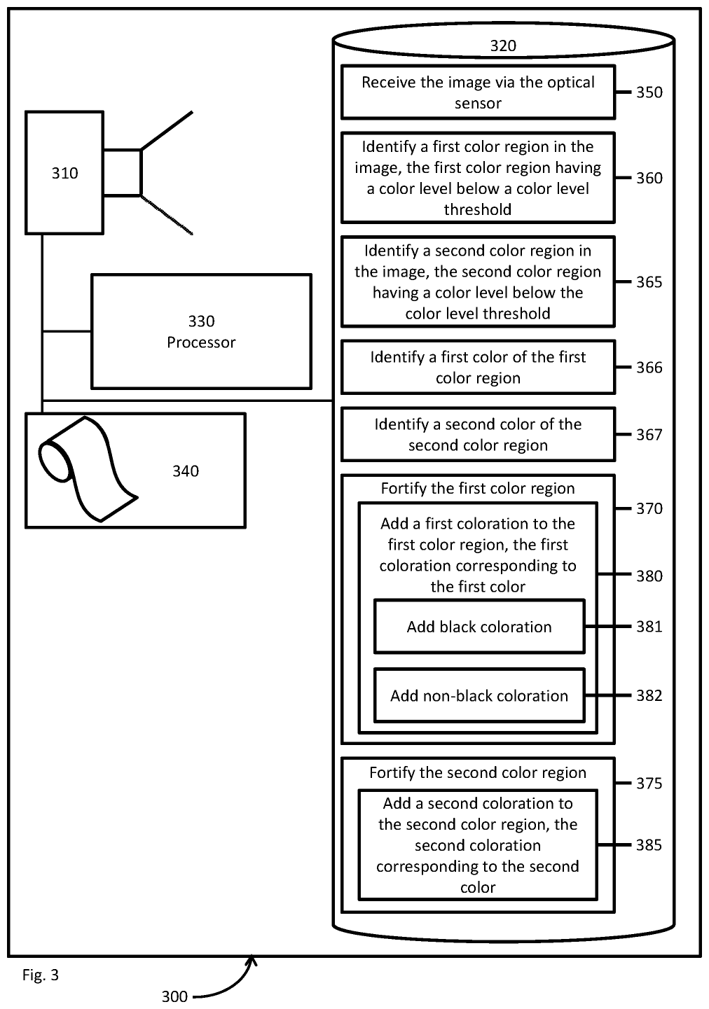

FIG. 3 shows a copier 300 that fortifies a first and second color region in accordance with various examples. The copier 300 may include an optical sensor 310, a computer-readable medium 320, a processor 330, and a printer 340.

The computer-readable medium 320 may include computer-readable instructions 350, 360, 365, 366, 367, 370, 380, 381, 382, 375, 385. Processor 330 may execute the computer-readable instructions 350, 360, 365, 366, 367, 370, 380, 381, 382, 375, 385. Machine-readable instruction 350 may cause the processor 330 to receive the image via the optical sensor. Machine-readable instruction 360 may cause the processor 330 to identify a first color region in the image, the first color region having a color level below a color level threshold. Machine-readable instruction 365 may cause the processor 330 to identify a second color region in the image, the second color region having a color level below the color level threshold. Machine-readable instruction 366 may cause the processor 330 to identify a first color of the first color region. Machine-readable instruction 367 may cause the processor 330 to identify a second color of the second color region. Machine-readable instruction 370 may cause the processor 330 to fortify the first color region. Machine-readable instruction 370 may include machine-readable instruction 380, which may include machine-readable instructions 381, 382. Machine-readable instruction 380 may cause the processor 330 to add a first coloration to the first color region, the first coloration corresponding to the first color. Machine-readable instruction 381 may cause the processor 330 to add black coloration. Machine-readable instruction 382 may cause the processor 330 to add non-black coloration. Machine-readable instruction 375 may cause the processor 330 to fortify the second color region. Machine-readable instruction 375 may include machine-readable instruction 385. Machine-readable instruction 385 may cause the processor 330 to add a second coloration to the second color region, the second coloration corresponding to the second color.

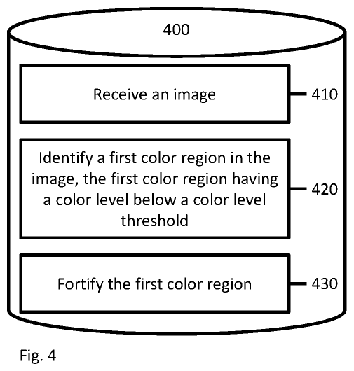

FIG. 4 shows a computer-readable medium 400 with machine-readable instructions 410, 420, 430 to fortify a color region in accordance with various examples. Machine-readable instructions 410, 420, 430 may be executable by a processor. Machine-readable instruction 410 may include instructions to receive an image. Machine-readable instruction 420 may include instructions to identify a first color region in the image, the first color region having a color level below a color level threshold. Machine-readable instruction 430 may include instructions to fortify the first color region.

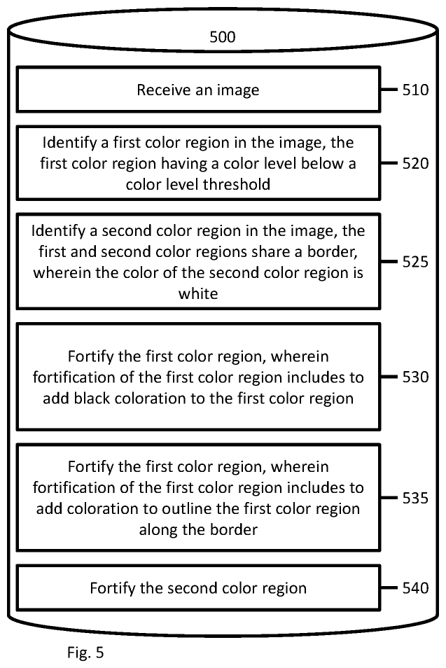

FIG. 5 shows a computer-readable medium 500 with machine-readable instructions 510, 520, 525, 530, 535, 540 to fortify a first and second color region in accordance with various examples. Machine-readable instructions 510, 520, 525, 530, 535, 540 may be executable by a processor. Machine-readable instruction 510 may include instructions to receive an image. Machine-readable instruction 520 may include instructions to identify a first color region in the image, the first color region having a color level below a color level threshold. Machine-readable instruction 525 may include instructions to identify a second color region in the image, the first and second color regions share a border, wherein the color of the second color region is white. Machine-readable instruction 530 may include instructions to fortify the first color region, wherein fortification of the first color region includes to add black coloration to the first color region. Machine-readable instruction 535 may include instructions to fortify the first color region, wherein fortification of the first color region includes to add coloration to outline the first color region along the border. Machine-readable instruction 540 may include instructions to fortify the second color region.

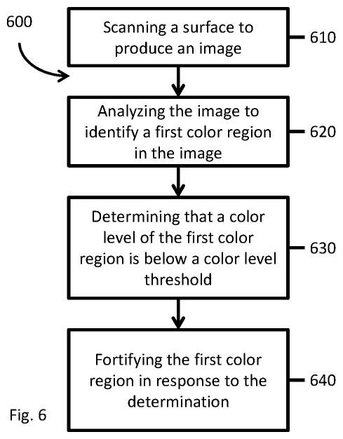

FIG. 6 shows a method 600 of scanning an image and fortifying a color region of the image in accordance with various examples. Method 600 may comprise scanning a surface to produce an image 610. Method 600 may comprise analyzing the image to identify a first color region in the image 620. Method 600 may comprise determining that a color level of the first color region is below a color level threshold 630. Method 600 may comprise fortifying the first color region in response to the determination 640.

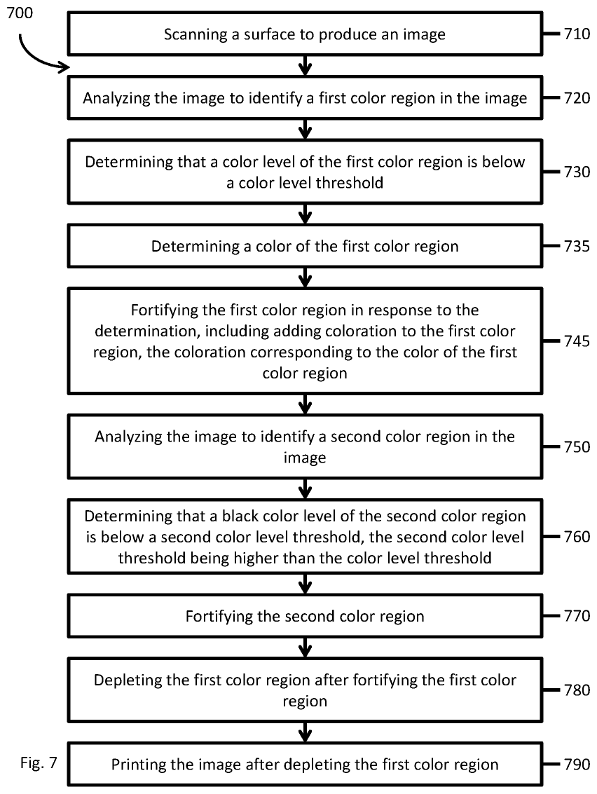

FIG. 7 shows a method 700 of scanning an image and fortifying a first and second color region of the image in accordance with various examples. Method 700 may comprise scanning a surface to produce an image 710. Method 700 may comprise analyzing the image to identify a first color region in the image 720. Method 700 may comprise determining that a color level of the first color region is below a color level threshold 730. Method 700 may comprise determining a color of the first color region 735. Method 700 may comprise fortifying the first color region in response to the determination, including adding coloration to the first color region, the coloration corresponding to the color of the first color region 745. Method 700 may comprise analyzing the image to identify a second color region in the image 750. Method 700 may comprise determining that a black color level of the second color region is below a second color level threshold, the second color level threshold being higher than the color level threshold 760. Method 700 may comprise fortifying the second color region 770. Method 700 may comprise depleting the first color region after fortifying the first color region 780. Method 700 may comprise printing the image after depleting the first color region 790.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A computer-readable medium storing machine-readable instructions that, when executed by a processor, cause the processor to:
receive an image;
identify a first color region in the image, the first color region having a color level below a color level threshold; and
fortify the first color region.

2. The computer-readable medium of claim 1, wherein fortification of the first color region includes to add black coloration to the first color region.

3. The computer-readable medium of claim 1, wherein the instructions, when executed by the processor, identify a second color region in the image, the first and second color regions share a border, and fortification of the first color region includes to add coloration to outline the first color region along the border.

4. The computer-readable medium of claim 3, wherein the color of the second color region is white.

5. The computer-readable medium of claim 3, wherein the instructions, when executed by the processor, cause the processor to fortify the second color region.

6. A method comprising:
scanning a surface to produce an image;
analyzing the image to identify a first color region in the image;
determining that a color level of the first color region is below a color level threshold; and
fortifying the first color region in response to the determination.

7. The method of claim 6 comprising determining a color of the first color region, and wherein fortifying the first color region includes adding coloration to the first color region, the coloration corresponding to the color of the first color region.

8. The method of claim 6 comprising depleting the first color region after fortifying the first color region.

9. The method of claim 8 comprising printing the image after depleting the first color region.

10. The method of claim 6 comprising:
analyzing the image to identify a second color region in the image;
determining that a black color level of the second color region is below a second color level threshold, the second color level threshold being higher than the color level threshold; and
fortifying the second color region.

11. An apparatus comprising:
an optical sensor to scan an image;
a computer-readable medium, coupled to a processor, to store machine-readable instructions which, when executed by the processor, cause the processor to:
receive the image via the optical sensor;
identify a first color region in the image, the first color region having a color level below a color level threshold; and
fortify the first color region; and
a printer coupled to the processor to print the image after fortification of the first color region by the processor.

12. The apparatus of claim 11, wherein the instructions, when executed by the processor, cause the processor to:
identify non-white color regions in the image;
fortify the non-white color regions in the image; and
deplete the non-white color regions in the image.

13. The apparatus of claim 12, wherein identification of the non-white color regions in the image comprises the identification of the first color region and an identification of a second color region, the second color region having a color level below the color level threshold, and fortification of the non-white color regions in the image comprises to add a first color density of coloration to the first color region and to add a second color density of coloration to the second color region, the first color density being 10% or more than the second color density.

14. The apparatus of claim 11, wherein the instructions, when executed by the processor, cause the processor to:
identify a second color region in the image, the second color region having a color level below the color level threshold;
identify a first color of the first color region;
identify a second color of the second color region; and
fortify the second color region, wherein fortification of the first color region includes to add a first coloration to the first color region, the first coloration corresponding to the first color, and fortification of the second color region includes to add a second coloration to the second color region, the second coloration corresponding to the second color.

15. The apparatus of claim 14, wherein addition of coloration corresponding to the first color region includes to add black coloration and to add non-black coloration.
